(19) United States
(12) Patent Application Publication
(10) Pub. No.: US 2011/0137998 A1
(43) Pub. Date: Jun. 9, 2011

(54) SYSTEM AND METHOD FOR DELIVERY OF NON-TEXTUAL CONTROLLER PILOT DATA LINK COMMUNICATIONS (CPDLC) FOR PILOT REVIEW

(75) Inventors: Thomas D. Judd, Woodinville, WA (US); John M. Horvath, Newcastle, WA (US)

(73) Assignee: HONEYWELL INTERNATIONAL INC., Morristown, NJ (US)

(21) Appl. No.: 12/631,011

(22) Filed: Dec. 4, 2009

(51) Int. Cl. G06F 3/048; G06F 15/16

(52) U.S. Cl. 709/206; 715/773; 709/217; 715/764

(57) ABSTRACT

An avionics system comprises a control device having an input/output interface to receive a Controller Pilot Data Link Communication (CPDLC) message; a textual-based Human-Machine Interface (HMI) coupled to the control device, the textual-based HMI operable to display textual content in the received CPDLC message based on instructions from the control device; and a graphical display unit coupled to the control device. The control device is operable to determine if graphical content is contained in the received CPDLC message. If the received CPDLC message contains graphical content, the control device is operable to send the graphical content to the graphical display unit and to provide instructions to the textual-based HMI to display a notification that the received CPDLC message contains graphical content.

### BACKGROUND

Controller Pilot Data Link Communications (CPDLC) systems provide communication between an Air Traffic Controller (ATC) and a pilot. Typical interfaces for CPDLC systems are textual Human-Machine Interfaces (HMI), such as the Multifunction Control and Display Unit (MCDU). However, the Radio Technical Commission for Aeronautics (RTCA) special committee 214 (SC 214) is developing uplink CPDLC communications which include graphical content, such as a map of the airport to communicate a graphic taxi route to the pilot. Typical CPDLC interfaces are not capable of displaying graphical content such as that being developed by the RTCA SC 214.

### SUMMARY

In one embodiment, an avionics system is provided. The avionics system comprises a control device having an input/output interface to receive a Controller Pilot Data Link Communication (CPDLC) message; a textual-based Human-Machine Interface (HMI) coupled to the control device, the textual-based HMI operable to display textual content in the received CPDLC message based on instructions from the control device; and a graphical display unit coupled to the control device. The control device is operable to determine if graphical content is contained in the received CPDLC message. If the received CPDLC message contains graphical content, the control device is operable to send the graphical content to the graphical display unit and to provide instructions to the textual-based HMI to display a notification that the received CPDLC message contains graphical content.

### DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1C are block diagrams depicting embodiments of a system for delivering CPDLC messages with graphical content to a pilot for review.

FIG. 2 is block diagram depicting one embodiment of a Communication Management Unit (CMU).

FIG. 3 is a front view of an exemplary Multi-function Control and Display Unit (MDCU)

FIG. 4 is a flow chart depicting one embodiment of a method of delivering CPDLC messages with graphical content to a pilot for review.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and in the specification is not to be construed as limiting the order in which the individual steps may be performed. The following detailed description is, therefore, not to be taken in a limiting sense.

Graphical content in Controller Pilot Data Link Communications (CPDLC) messages cannot be displayed using the existing textual based Human-Machine Interfaces (HMI) such as the Multifunction Control and Display Units (MCDUs). Not displaying the graphical content prevents a pilot from taking advantage of the benefits of the graphical content in the CPDLC messages. However, replacing the MCDUs in the many existing aircraft in order to support Controller Pilot Data Link Communications (CPDLC) messages having graphical content would be expensive and cost prohibitive. In addition, the textual-based MCDU is the current interface of choice by many pilots. The cost involved in training pilots on a new interface system is another barrier to replacing the typical textual-based MCDU. The embodiments described below enable display of graphical content in CPDLC messages without the need to replace current avionics equipment.

As used herein, the term textual-based display unit refers to a display unit configured to display text only. Similarly, the term textual-based HMI refers to a human-machine interface which includes one or more user input devices and a textual-based display unit. The term, graphical display unit, as used herein, refers to a display unit that is configured to display graphics or other images in addition to or instead of text.

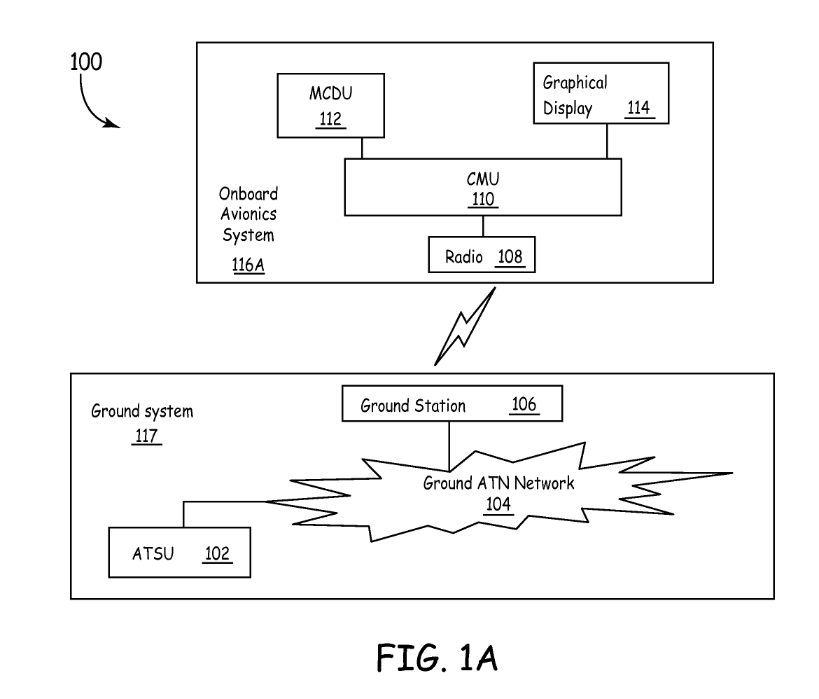

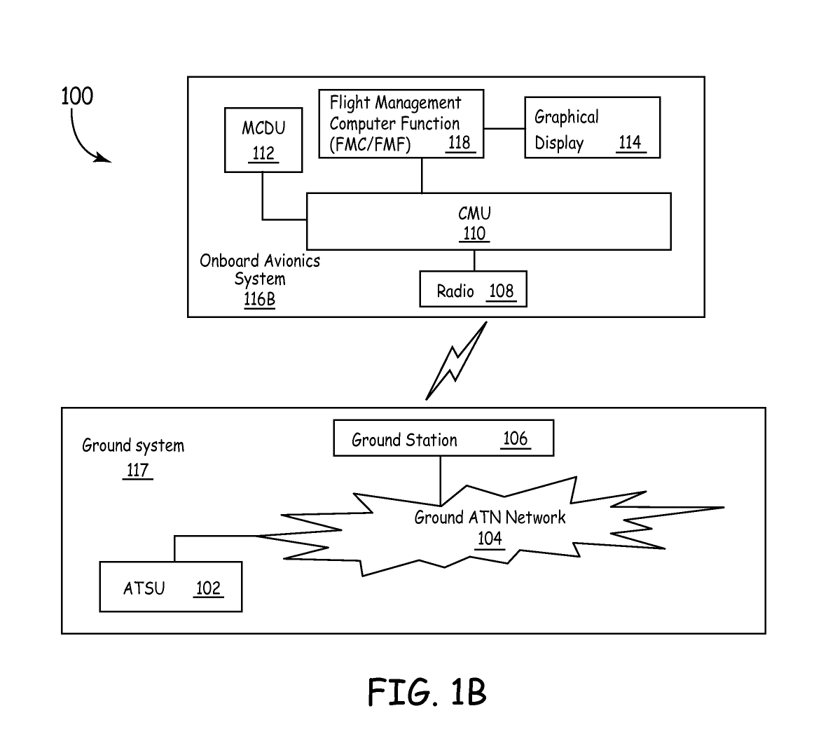

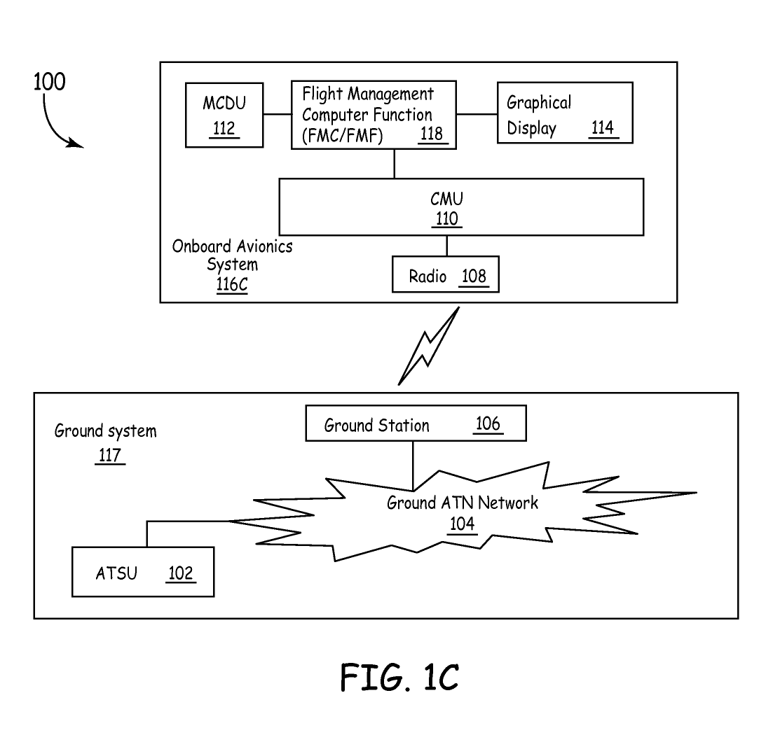

FIG. 1A is a block diagram of one embodiment of a system 100 for delivering graphical content in CPDLC messages to a pilot for review. System 100 includes an avionics system 116A onboard an aircraft in communication with a ground system 117. The avionics system 116A includes a radio 108, a Communication Management Unit (CMU) 110, a textual-based Human-Machine Interface (HMI) 112, and a graphical display unit 114. Notably, the textual-based HMI 112 in this embodiment is a MCDU. However, it is to be understood that other textual-based HMIs can be used in other embodiments, such as a Control and Display Unit (CDU). The ground system 117 includes an Air Traffic Services Unit (ATSU) 102 coupled to a ground station 106 via the Aeronautical Telecommunications Network (ATN) 104.

The ATSU 102 prepares and sends a CPDLC message having graphical content to the onboard avionics system 116A via the ground station 106. The ground station 106 can be implemented as a station configured for one of Very High Frequency (VHF) communications, High Frequency (HF) communications, Satellite Communications (SATCOM), or other appropriate communication technology known to one of skill in the art for communication between a ground station and an aircraft. The radio 108 in the onboard avionics system 116A is implemented according to the communication technology corresponding to the ground station 106. In addition, in some embodiments, more than one radio 108 and more than one ground station 106 can be used in system 100. For example, each radio 108 and corresponding ground station 106 can be implemented according to a different communication technology.

The CMU 110 is coupled to the radio 108 to receive the CPDLC message having graphical content. The CMU 110 identifies the CPDLC message as containing graphical content. For example, the CMU 110 can read a message identifier in the CPDLC message which indicates that there is graphical content in the CPDLC message. When the CMU 110 identifies the CPDLC message as containing graphical content, the CMU 110 forwards the textual-portion of the CPDLC message to the MCDU 112 for display. In addition, the CMU 110 provides instructions to the MCDU 112 to display a textual message to the pilot indicating that the CPDLC message contains graphical content.

In addition, the MCDU 112, in this embodiment, displays a message to request pilot input to send the graphical content to a separate graphical display unit 114. Upon receiving the requested input, the MCDU 112 relays the pilot input to the CMU 110. The CMU 110 then sends the graphical content to the separate graphical display unit 114. In other embodiments, the CMU 110 automatically sends the graphical content to the separate graphical display unit 114. In some such embodiments, the CMU 110 instructs the MCDU 112 to provide an indication to the pilot that the graphical content was sent to the graphical display unit 114.

The graphical display unit 114 can be implemented as any display unit which is capable of displaying graphical content. Suitable exemplary display units include, but are not limited to, a graphical display associated with the Electronic Flight Bag and a graphical display associated with the Flight Management Computer (FMC). For example, the avionics system 116B in FIG. 1B includes FMC 118. CMU 110 provides the graphical content to FMC 118. The FMC 118 then provides the graphical content to graphical display unit 114 for display. The Electronic Flight Bag and the Flight Management Computer are avionics components known to one of skill in the art.

In addition, it should be noted that the CMU 110 in FIGS. 1A and 1B includes both the protocol stack and data link applications. For example, the CMU 110 includes the ATN stack and Aircraft Communications Addressing and Reporting System (ACARS) stack, as well as Air Traffic Control data link applications. However, in other embodiments, the data link applications are implemented in the Flight Management Computer as shown in FIG. 1C. For example, the Future Air Navigation System (FANS) can be implemented in the FMC to provide direct data link communication between the pilot and the ATC. As shown in FIG. 1C, the CMU 110 provides the CPDCL message to the FMC 118. The FMC 118 in turn communicates with the MCDU 112 to deliver at least the textual portion of the CPDLC message. When the CPDLC message contains graphical content, the FMC 118 delivers the graphical content to the graphical display unit 114. The MCDU 112 can be used to accept or reject a CPDLC message containing a textual or data-type flight plan that is loaded into the FMC 118 for review as well as graphical content which is displayed on the graphical display unit 114.

In particular, after reviewing the graphical content on the graphical display unit 114, the pilot can respond to the CPDLC message using the MCDU 112. For example, the pilot can accept or reject the CPDLC message via the MCDU 112. Alternatively, the pilot can create a new message in response to the received CPDLC message. The MCDU 112 provides the pilot's response to the CMU 110, which transmits the message via the radio 108 to ground system 117. In embodiments where the data link applications are located in the FMC 118, the MCDU 112 provides the pilot's response to the FMC 118 which is responsible for directing communication with the ground system 117. The ground station 106 receives the pilot's response and provides the pilots response to the ATSU 102 via the ATN network 104.

Hence, the embodiments of the onboard avionics system 116 described above are capable of providing the graphical content of a CPDLC message to a pilot without replacing the existing components. For example, existing CMUs and/or FMCs can be updated with a firmware update to provide the functionality discussed herein. Furthermore, even in implementations in which the CMU is replaced to implement the functionality discussed above, the cost of replacement is reduced. In particular, training of pilots to use a new HMI in place of current MCDUs is avoided.

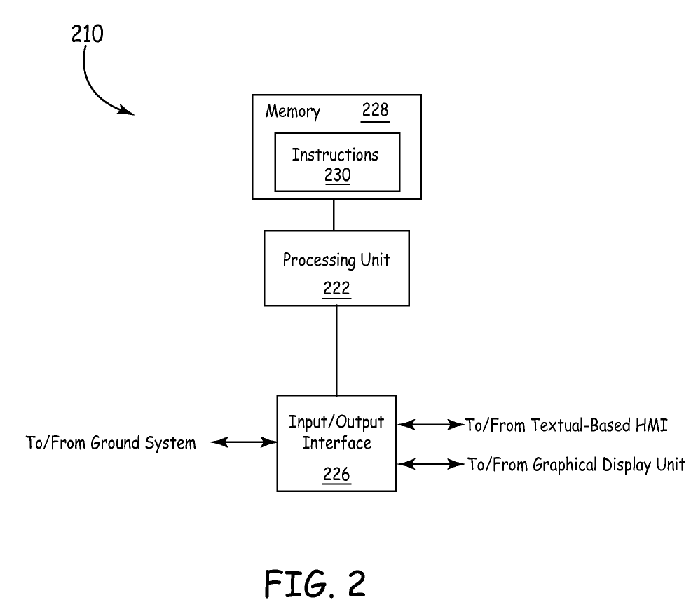

FIG. 2 is a block diagram of one embodiment of a CMU 210 which can be used in onboard avionics system 116 discussed above. The CMU 210 includes processing unit 222 coupled to an input/output (I/O) interface 226 and a memory 228. Processing unit 222 includes or functions with software programs, firmware or other computer readable instructions for carrying out various methods, process tasks, calculations, and control functions, used in the processing of CPDLC messages.

These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc. Suitable processor-readable media may also include transmission media such as electrical, electromagnetic, or digital signals, conveyed via a communication medium such as a network and/or a wireless link.

For example, in the embodiment of FIG. 2, the memory 228 stores instructions 230 which are executed by processing unit 222 to process CPDLC messages having graphical content as described above. In operation, processing unit 222 receives a CPDLC message having graphical content via I/O interface 226. Processing unit 222 determines if the CPDLC message contains graphical content based on the message identifier of the CPDLC message. Processing unit 222 then provides instructions to the textual-based HMI, such as MCDU 112, to display a textual message to the pilot indicating that there is graphical content in the message. In addition, in this example, the textual message requests user input to send the graphical content to a separate graphical display unit. In other embodiments, the graphical content is automatically sent to the graphical display unit and the textual message includes information indicating that the graphical content was sent to the graphical display unit. In some such embodiments, the processing unit 222 also sends instructions to the textual-based HMI to display a textual message indicating the status of the graphical content. For example, the processing unit 222 causes a textual message to be displayed which indicates if the graphical content was successfully transferred, if the transfer is pending, or if the transfer of the graphical content to the graphical display unit failed.

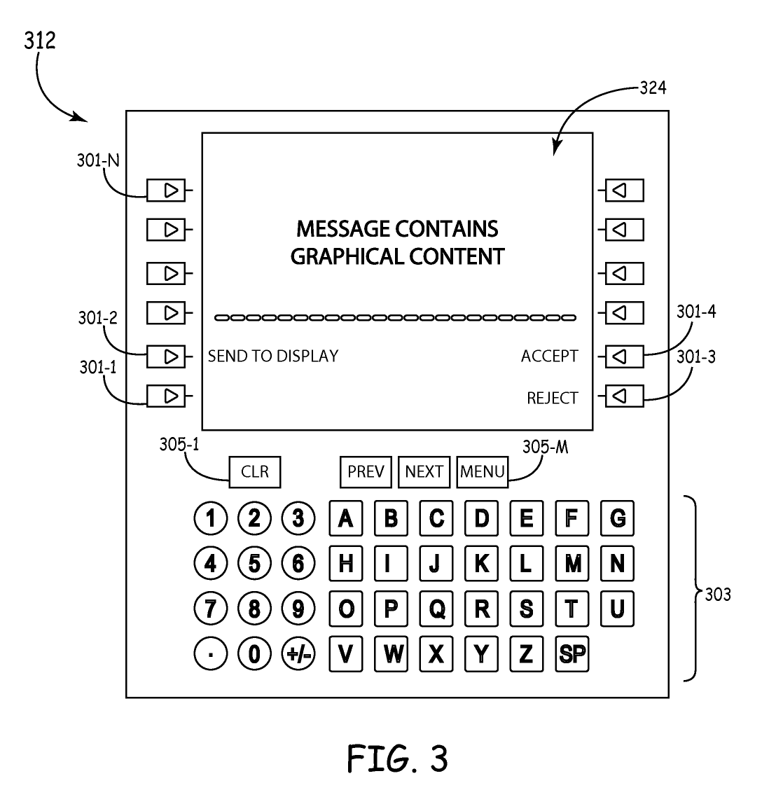

After receiving user input from the textual-based HMI via I/O interface 226, the processing unit 222 outputs the graphical content of the CPDLC message via I/O interface 226 to the separate graphical display unit. After viewing the graphical content, the pilot can respond to the message via the textual-based HMI. In particular, the processing unit 222 can provide instructions or commands to the textual-based HMI to display a request for the pilot to accept or reject the CPDLC message. Exemplary user input devices are shown and described below with respect to the textual-based HMI shown in FIG. 3. Upon receiving the pilot's response from the textual-based HMI, the processing unit 222 formats and outputs the response via I/O interface 226 to the ground system.

Notably, although FIG. 2 is described with respect to a CMU, it is to be understood that similar elements and functionality can also be implemented in other control devices, such as a FMC. In addition, in some embodiments, the pilot is able to accept or reject the graphical content of the CPDLC message via the graphical display unit. In particular, the processing unit 222 provides instructions to the graphical display unit to provide a message requesting user input via a user input device associated with the graphical display unit.

FIG. 3 is a front view of an exemplary MCDU 312. MCDU 312 includes a plurality of user input devices. In particular, MCDU 312 includes pre-defined function buttons 305-1 . . . 305-M, action buttons 301-1 . . . 301-N, and alpha-numeric keypad 303. In addition, MCDU 312 includes textual-based display 324. In some embodiments, textual-based display 324 uses touch-screen technology for user input as known to one of skill in the art. In some such embodiments, the touch-screen technology is used in place of pre-defined buttons 305-1 . . . 305-M, action buttons 301-1 . . . 301-N, and/or alpha-numeric keypad 303.

Pre-defined function buttons 305-1 . . . 305-M are buttons which are permanently associated with a particular functionality, such as moving to the next or previous screen, displaying a menu, etc. Action buttons 301-1 . . . 301-N are buttons which are associated with different functions depending on the message or information displayed on textual-based display 324. For example, in the embodiment shown in FIG. 3, textual-based display 324 presents a textual notification that the received CPDLC message includes graphical content. Action button 301-2 is thus temporarily associated with the function of sending the graphical content to a separate graphical display unit. Action buttons 301-3 and 301-4 are temporarily associated with the functions of rejecting or accepting the message, respectively. After the message is accepted or rejected, the action buttons 301-2, 301-3, and 301-4 may be associated with a different function for the next message.

Notably, although the action button 301-2 is associated with the function of sending the graphical content to a separate graphical display unit, other embodiments are not to be so limited. For example, in some embodiments, a notification displayed on textual-based display 324 indicates a key or series of keys to press on the alpha-numeric keypad 303 in order to send the graphical content to a separate graphical display unit. Furthermore, it is to be understood that the specific layout of the action buttons 301-1 . . . 301-N, the pre-defined function buttons 305-1 . . . 305-M, and the alpha-numeric keypad 303 can be implemented in various configurations and the layout is not limited to the layout depicted in the exemplary embodiment shown in FIG. 3.

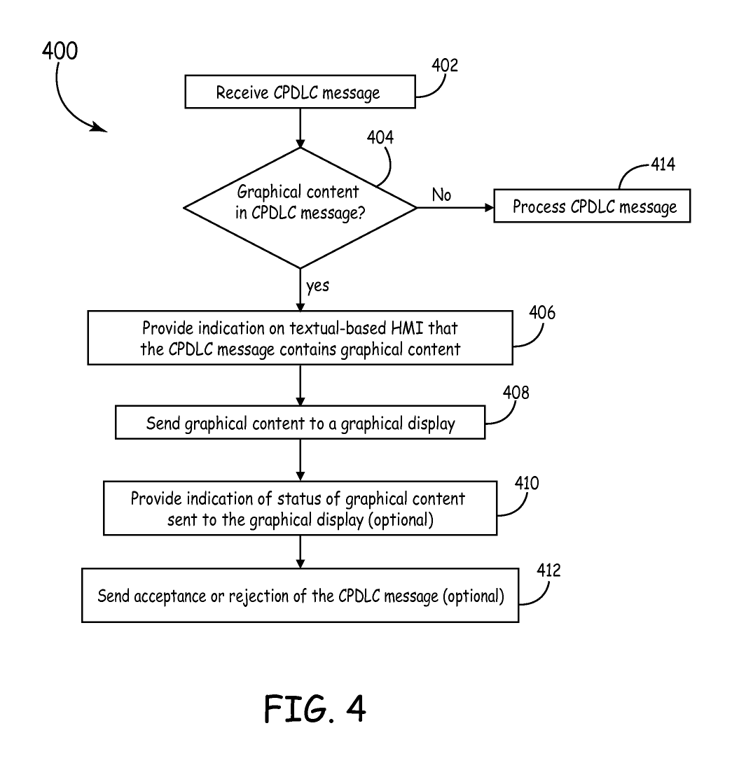

FIG. 4 is a flow chart depicting a method 400 of delivering CPDLC messages with graphical content to a pilot for review. At 402, a CPDLC message is received. At block 404, it is determined if the CPDLC message contains graphical content. For example, in some embodiments, the message identifier of the CPDLC message indicates that the CPDLC message includes graphical content. If it is determined that the CPDLC message contains graphical content, an indication is provided, at block 406, on a textual-based HMI, such as an MCDU, which notifies the pilot that the message contains graphical content.

At block 408, the graphical content of the CPDLC message is sent to a separate graphical display unit. For example, in some embodiments, the graphical content is automatically sent to the graphical display unit and the indication provided via the textual-based HMI, at block 406, notifies the pilot that the graphical content has been sent to the graphical display unit. In other embodiments, user input is requested via the textual-based HMI in order to send the graphical content to the graphical display unit. Once, the user input is received indicating that the graphical content should be sent, the graphical content is sent to the graphical display unit for review by the pilot. In some embodiments, a textual portion of the CPDLC message is sent to the graphical display unit with the graphical content. In other embodiments, only the graphical content is sent to the graphical display unit and the textual portion is displayed via the textual-based HMI. At 410, an indication of the status of the graphical content is optionally provided to the pilot via the textual-based HMI. In particular, a textual message is displayed indicating whether or not the graphical content was successfully received by the graphical display unit. At block 412, an acceptance or rejection of the CPDLC message is sent to the ground system. For example, in some embodiments, the pilot can accept or reject the CPDLC message via the textual-based HMI. In other embodiments, the pilot can accept or reject the CPDLC message via the graphical display unit. In some such embodiments, the MCDU page containing the textual portion of the CPDLC corresponding to the graphical content is synchronized/updated to reflect the acceptance or rejection of the CPDLC message provided via the graphical display unit.

If it is determined, at block 404, that that CPDLC message does not contain graphical content, the CPDLC message is processed using existing procedures for non-graphical content at block 414. Hence, method 400 enables a pilot to review graphical content of a CPDLC message without requiring the existing textual-based HMI to be replaced with a graphical HMI. The pilot is then able to accept or reject the message as normally done with textual CPDLC messages.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An avionics system comprising:
a control device having an input/output interface to receive a Controller Pilot Data Link Communication (CPDLC) message;
a textual-based Human-Machine Interface (HMI) coupled to the control device, the textual-based HMI operable to display textual content in the received CPDLC message based on instructions from the control device; and
a graphical display unit coupled to the control device;
wherein the control device is operable to determine if graphical content is contained in the received CPDLC message; and
wherein if the received CPDLC message contains graphical content, the control device is operable to send the graphical content to the graphical display unit and to provide instructions to the textual-based HMI to display a notification that the received CPDLC message contains graphical content.

2. The avionics system of claim 1, wherein the control device is operable to automatically send the graphical content to the graphical display unit.

3. The avionics system of claim 1, wherein the control device is one of a Flight Management Computer and a Communication Management Unit.

4. The avionics system of claim 1, wherein the control device is operable to send instructions to the textual-based HMI to display the status of the graphical content sent to the graphical display unit.

5. The avionics system of claim 1, wherein the control device is operable to provide instructions to the textual-based HMI to display a request for user input via a user input device of the textual-based HMI, the user input indicating if the graphical content is to be sent to the graphical display unit.

6. The avionics system of claim 5, wherein the user input device comprises one or more of:
at least one pre-defined function button permanently associated with a specific function;
at least one action button temporarily associated with a specific function based on data being displayed on the textual-based screen;
an alpha-numeric keypad; and
a touch-screen incorporated in the textual-based screen.

7. The avionics system of claim 1, wherein the control device is further operable to send instructions to the textual-based HMI to display a request for a user to accept or reject the received CPDLC message via a user input device of the textual-based HMI.

8. A method of delivering graphical content in Controller Pilot Data Link Communication (CPDLC) messages to a pilot, the method comprising:
receiving a CPDLC message;
determining if the CPDLC message contains graphical content;
if the CPDLC message contains graphical content, providing an indication on a textual-based Human-Machine Interface that the CPDLC message contains graphical content; and
if the CPDLC message contains graphical content, sending the graphical content to a graphical display unit.

9. The method of claim 8, wherein determining if the CPDLC message contains graphical content comprises determining if the CPDLC message contains graphical content based on a message identifier in the CPDLC message.

10. The method of claim 8, wherein the graphical display unit is one of an Electronic Flight Bag display and a Flight Management Computer display.

11. The method of claim 8, wherein sending the graphical content to the graphical display unit comprises automatically sending the graphical content to the graphical display unit.

12. The method of claim 8, wherein sending the graphical content to the graphical display unit comprises sending the graphical content based on user input received via the textual-based HMI.

13. The method of claim 8, further comprising providing, via the textual-based HMI, an indication of the status of the graphical content sent to the graphical display unit.

14. The method of claim 8, further comprising sending an acceptance or a rejection of the CPDLC message via the textual-based HMI.

15. A program product comprising a processor-readable medium on which program instructions are embodied, wherein the program instructions are operable, when executed by at least one programmable processor, to cause the at least one programmable processor to:
determine if a received Controller Pilot Data Link Communication (CPDLC) message contains graphical content;
provide instructions to a textual-based Human-Machine Interface (HMI) to display a textual message indicating that there is graphical content in the CPDLC message if it is determined that the CPDLC message contains graphical content; and
output the graphical content of the CPDLC message to a graphical display if it is determined that the CPDLC message contains graphical content.

16. The program product of claim 15, wherein the program instructions are further operable to cause the at least one programmable processor to:
determine if the received CPDLC message contains graphical content based on a message identifier in the CPDLC message.

17. The program product of claim 15, wherein the program instructions are further operable to cause the at least one programmable processor to:
send instructions to the textual-based HMI to display a textual message indicating the status of the graphical content output to the graphical display.

18. The program product of claim 15, wherein the program instructions are further operable to cause the at least one programmable processor to:
output automatically the graphical content of the CPDLC message to the graphical display.

19. The program product of claim 15, wherein the program instructions are further operable to cause the programmable processor to:
output the graphical content of the CPDLC message to the graphical display in response to user input received via the textual-based HMI.

20. The program product of claim 15, wherein the program instructions are further operable to cause the at least one programmable processor to:
provide instructions to the textual-based HMI to display a request for user input to accept or reject the CPDLC message.
